(19) United States
(12) Patent Application Publication
(10) Pub. No.: US 2015/0199279 A1
(43) Pub. Date: Jul. 16, 2015

(54) METHOD AND SYSTEM FOR METHOD FOR TRACKING TRANSACTIONS ASSOCIATED WITH A SYSTEM MEMORY MANAGEMENT UNIT OF A PORTABLE COMPUTING DEVICE

(71) Applicant: QUALCOMM INCORPORATED, SAN DIEGO, CA (US)

(72) Inventor: OLAV HAUGAN, SAN DIEGO, CA (US)

(73) Assignee: QUALCOMM INCORPORATED, SAN DIEGO, CA (US)

(21) Appl. No.: 14/155,298

(22) Filed: Jan. 14, 2014

(51) Int. Cl. G06F 12/10; G06F 12/12

(52) U.S. Cl. CPC G06F 12/1009; G06F 12/12; G06F 2212/68; G06F 2212/69

(57) ABSTRACT

A method and system for tracking transactions associated with a system memory management unit (“SMMU”) includes receiving a plurality of memory requests from a plurality of processing elements and storing contents of each memory request in a transaction history buffer (“THB”). The contents of a memory request stored in the THB may comprise at least one of a security bit; a Virtual Machine Identifier (“VMID”); a Stream identifier (“SID”); a SMMU Context Bank that was used; and whether or not the virtual address was present in the translation look-aside buffer. A status for a lock command for the THB may be stored in the transaction history buffer. Action taken by the SMMU in response to a memory request may also be stored in the THB. With this data stored in the THB, root causes for errors within the portable computing device may be determined.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

To increase portability of PCDs, many PCD manufacturers employ compact electronics and electronic packaging arrangements. One element that allows for these compact electronics and electronic packaging arrangements is a System-on-Chip (“SoC”) design. SoCs are extremely complicated and usually have several subsystems that have to reliably work together so that a PCD functions properly.

Debugging and testing PCDs employing SoCs are very difficult. Intermittent and very hard to reproduce issues may occur frequently and root cause analysis (“RCA”) is often very difficult. Examples of issues faced by PCDs with SoCs are intermittent hardware problems, double-data rate (“DDR”) memory corruption issues, bus overflows, and bad memory accesses.

Many of the problems faced in SoC design are often related to system memory management units (“SMMUs”) and memory accesses (or invalid register accesses). More and more of the subsystems in a SoC have SMMUs that may help in debugging. However, there is currently no way for SoC engineers to know the sequence of events which occur in connection with SMMUs and that lead up to potential root problems.

Accordingly, what is needed in the art is a method and system for tracking transactions associated with a system memory management unit.

### SUMMARY OF THE DISCLOSURE

A method and system for tracking transactions associated with a system memory management unit includes receiving a plurality of memory requests from a plurality of processing elements and storing contents of each memory request in a transaction history buffer. Next, it is determined if a virtual address in each memory request exists in a translation look-aside buffer. A physical address may be retrieved from the translation look-aside buffer if it exists in the translation look-aside buffer and the physical address together with an indicator that the physical address came from the transaction lookaside buffer is then stored in the transaction history buffer.

Subsequently, a context bank may be accessed and an address of a page table in memory is identified corresponding to a processing element that originated a respective memory request. The context bank index may be stored in the transaction history buffer corresponding to the memory request.

A hardware table walk may be conducted in accordance with the context data. An assigned page table may be accessed in memory based on the virtual address of the memory request. A result of the assigned page table access and any action taken by a system memory management unit in response to the result of the assigned page table access may be stored in the transaction history buffer.

The contents of a memory request stored in the transaction history buffer may comprise at least one of a security bit; a Virtual Machine Identifier (“VMID”); a Stream identifier (“SID”); a SMMU Context Bank that was used; whether or not the virtual address was present in the translation look-aside buffer. A status for a lock command for the transaction history buffer may be stored in the transaction history buffer. Action taken by a system memory management unit in response to a memory request may be stored in the transaction history buffer. Such action may include at least one of: storing a bypass mode status in the transaction history buffer; storing a translated address; storing a Page Fault for a physical address in response to a memory request; and storing a Global Fault in response to in response to a memory request. Other data which may be stored in the transaction history buffer may include whether a physical address access by a processing element behind a memory request caused a timeout/error on the bus. With this data stored in the THB, root causes for errors within the portable computing device may be determined.

### BRIEF DESCRIPTION OF THE DRAWINGS

In the figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1A is a functional block diagram illustrating an embodiment of a portable computing device (“PCD”) having a system for tracking transactions associated with a system memory management unit;

FIG. 1B is a front view of an exemplary embodiment of the PCD of FIG. 1A such as a mobile phone;

FIG. 2A is a functional block diagram illustrating an exemplary system for tracking transactions associated with a system memory management unit;

FIG. 2B is a functional block diagram illustrating an alternative exemplary system for tracking transactions associated with a memory management unit; and

FIG. 3A is a logical flowchart illustrating a method for tracking transactions associated with a system memory management unit.

FIG. 3B is a continuation logical flowchart corresponding to FIG. 3A.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) and fourth generation (“4G”) wireless technology, greater bandwidth availability has enabled more portable computing devices with a greater variety of wireless capabilities.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) wireless technology, have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, and a laptop computer with a wireless connection, among others.

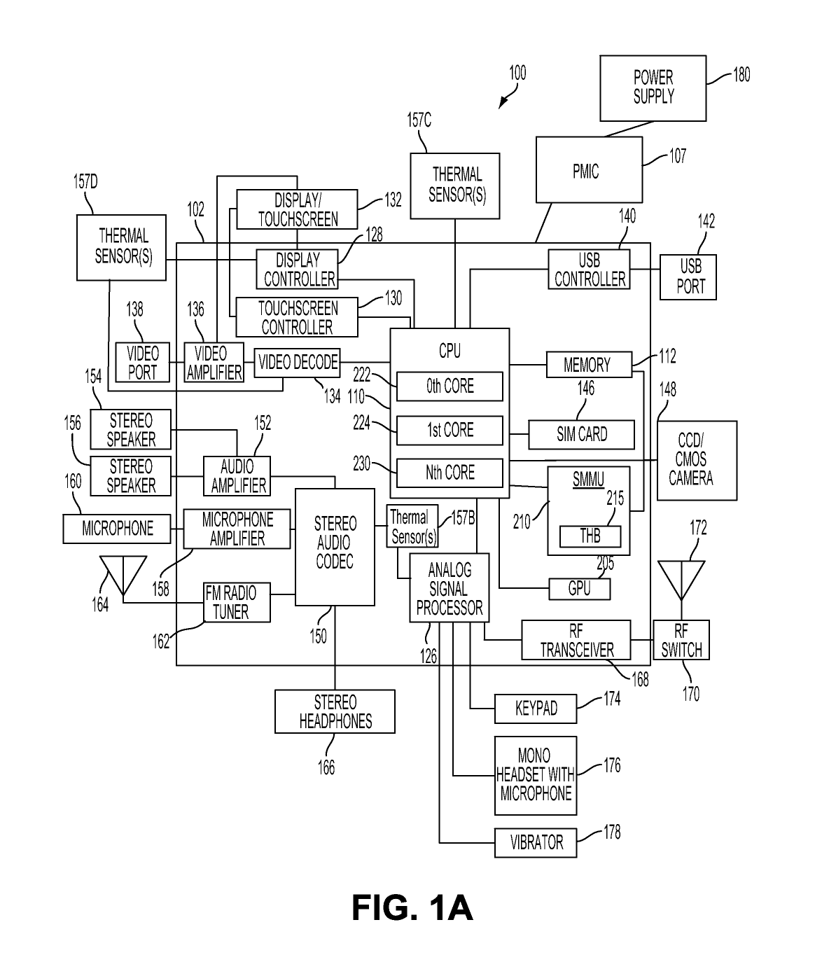

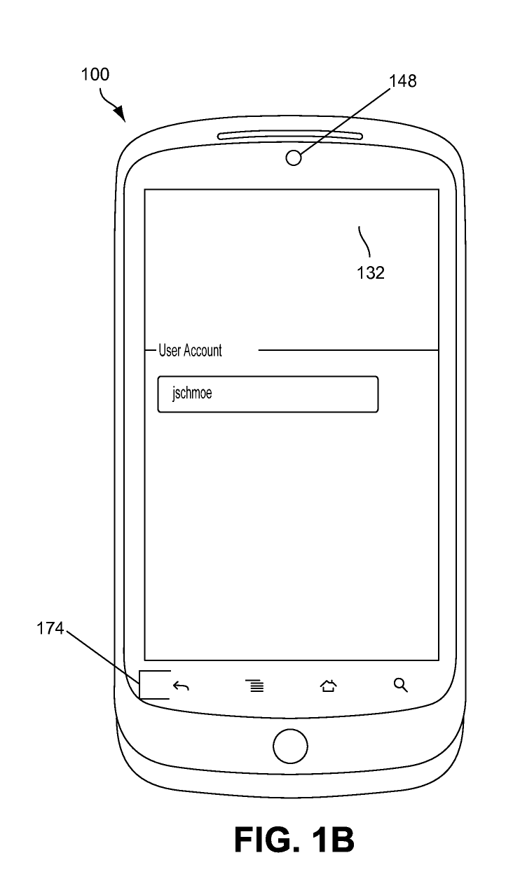

Referring to FIG. 1A, this figure is a functional block diagram of an exemplary, non-limiting aspect of a PCD 100 in the form of a wireless telephone for implementing methods and systems for tracking transactions associated with a system memory management unit 210. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Instead of a CPU 110, a digital signal processor (“DSP”) may also be employed as understood by one of ordinary skill in the art.

The CPU 110 may also be coupled to one or more internal, on-chip thermal sensors 157A as well as one or more external, off-chip thermal sensors 157B. The PCD 100 of FIG. 1A may also include a graphical processing unit 205 responsible for managing any graphics used via the display controller 128 and display/touchscreen 132.

The PCD 100 may also include memory 112 which is coupled to a system memory management unit (“SMMU”) 210. The SMMU 210 may be coupled to the GPU 205 and CPU 110. The SMMU 210 is generally responsible for managing memory requests received from a plurality of multiple processing elements which may include processing elements, such as, but not limited to, the GPU 205 and CPU 110.

The SMMU 210 is different from conventional memory management units (“MMUs”) since conventional MMUs are usually housed within a CPU 110 and usually only service a single processing element, such as a CPU 110, and not multiple processing elements.

The SMMU 210 comprises hardware that generally is responsible for having all memory references passed through itself, primarily performing the translation of virtual memory addresses to physical addresses. The SMMU 210 is usually implemented as a separate physical entity relative to the plurality of processing elements 205 that it serves. As noted above, this physical separation from processing elements 205 is at least one distinguishing feature of the SMMU 205 relative to a conventional MMU.

The SMMU 210 may include a transaction history buffer (“THB”) 215.

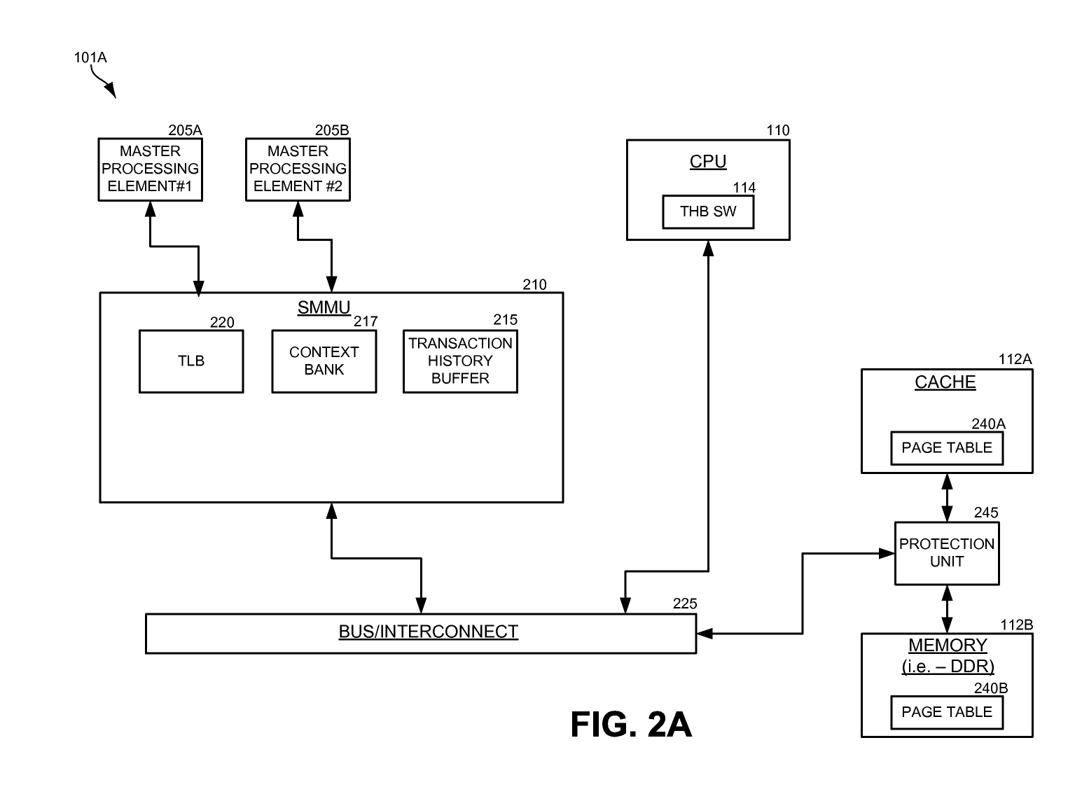

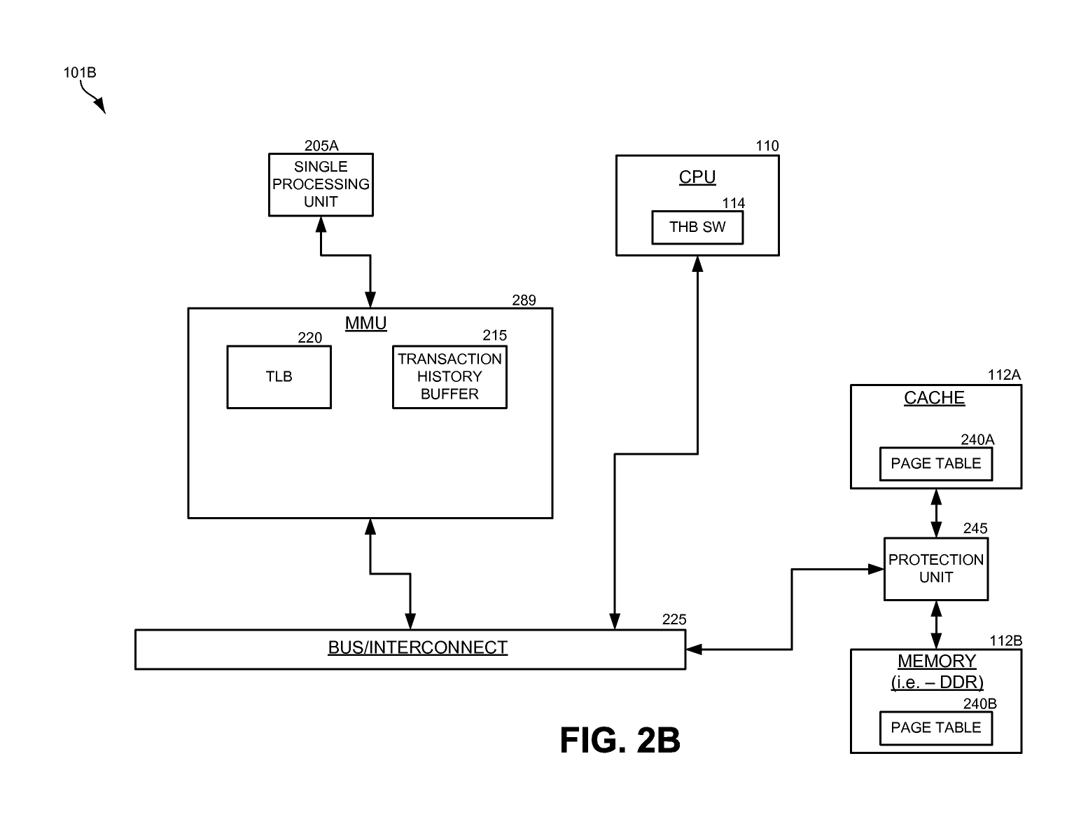

In a particular aspect, one or more of the method steps described herein may be implemented by executable instructions and parameters, stored in the memory 112. Further, SMMU 210, THB 215, the memory 112, and/or instructions stored therein, or a combination thereof may serve as a means for performing one or more of the method steps described herein for tracking transactions associated with a system memory management unit. Further details of the SMMU 210 and THB 215 will be described in detail below in connection with FIG. 2A.

The power manager integrated controller (“PMIC”) 107 may be responsible for distributing power to the various hardware components present on the chip 102. The PMIC is coupled to a power supply 180. The power supply 180, may comprise a battery and it may be coupled to the on-chip system 102. In a particular aspect, the power supply may include a rechargeable direct current (“DC”) battery or a DC power supply that is derived from an alternating current (“AC”) to DC transformer that is connected to an AC power source.

As illustrated in FIG. 1A, a display controller 128 and a touchscreen controller 130 are coupled to the multi-core processor 110. A touchscreen display 132 external to the on-chip system 102 is coupled to the display controller 128 and the touchscreen controller 130.

FIG. 1A is a schematic diagram illustrating an embodiment of a portable computing device (PCD) that includes a video encoder/decoder 134. The video decoder 134 is coupled to the multicore central processing unit (“CPU”) 110. A video amplifier 136 is coupled to the video decoder 134 and the touchscreen display 132. A video port 138 is coupled to the video amplifier 136. As depicted in FIG. 1A, a universal serial bus (“USB”) controller 140 is coupled to the CPU 110. Also, a USB port 142 is coupled to the USB controller 140. A memory 112 and a subscriber identity module (“SIM”) card 146 may also be coupled to the CPU 110.

Further, as shown in FIG. 1A, a digital camera or camera subsystem 148 may be coupled to the CPU 110. In an exemplary aspect, the digital camera/cameral subsystem 148 is a charge-coupled device (“CCD”) camera or a complementary metal-oxide semiconductor (“CMOS”) camera.

As further illustrated in FIG. 1A, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 1A shows that a microphone amplifier 158 may be also coupled to the stereo audio CODEC 150. Additionally, a microphone 160 may be coupled to the microphone amplifier 158.

In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 1A further indicates that a radio frequency (“RF”) transceiver 168 may be coupled to the analog signal processor 126. An RF switch 170 may be coupled to the RF transceiver 168 and an RF antenna 172. As shown in FIG. 1A, a keypad 174 may be coupled to the analog signal processor 126. Also, a mono headset with a microphone 176 may be coupled to the analog signal processor 126. Further, a vibrator device 178 may be coupled to the analog signal processor 126.

As depicted in FIG. 1A, the touchscreen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, and the power supply 180 are external to the on-chip system 102.

Referring now to FIG. 1B, this figure is a front view of one exemplary embodiment of a portable computing device (“PCD”) 100 such as a mobile phone. The PCD 100 has a large touchscreen 132 in its mid-section and smaller keypad/buttons 174 near a lower, first end of the device 100. A “frontward/user” facing camera 148 may be positioned near a top, second end of the device 100. While a touchscreen type mobile phone 100 has been illustrated, other mobile phone types are possible and are within the scope of this disclosure, such as mobile phones 100 that have dedicated key boards which may be placed in a fixed position or which may be slideable inward (in a hidden position) and outward (in a visible/usable position) relative to the device 100.

Referring now to FIG. 2A, this figure illustrates a system 101 for tracking transactions associated with a system memory management unit (“SMMU”) 210. The system 101 may comprise one or more master processing elements 205, an SMMU 210, a transaction history buffer (“THB”) 215, a communication bus 225, THB software 114 running on a CPU 110, and memory elements 112 coupled to a protection unit 245. The memory elements 11 may include, but are not limited to, cache memory 112A and double-data rate (“DDR”) type memory 112B. Other types of memory elements 112 may be used and are within the scope of this disclosure.

The protection unit 245 is an optional component of the system 101. The protection unit may perform a gate-keeping function for the two memory elements 112. It can determine whether a memory request containing a physical address is valid and if the request should be permitted access to a respective memory element 112. The protection unit may issue protection fault messages in response to memory requests that are not permitted access to the one or more memory elements 112. These protection fault messages may be stored in the transaction history buffer (“THB”) 215 as will be described in further detail below.

The one or more master processing elements 205 may include, but are not limited to, a central processing unit 110 which may be single core or multicore, a graphical processing unit 205, a digital signal processor, and other like processing elements 205 for portable computing devices, such as mobile phones.

Each master processing element 205 may be coupled to the SMMU 210 for managing its respective memory requests that are issued. The SMMU 210 may comprise a THB 215, a context bank 217, and a translation lookaside buffer (“TLB”) 220.

The TLB 220 may comprise a cache that the SMMU 210 uses to improve virtual address translation speed. A portable computing device, such as a mobile phone 100, desktop, laptop, and computer server processors may include one or more TLBs 220 in the memory management hardware, and it is usually present in any hardware that utilizes paged virtual memory. The TLB 220 may be implemented as content-addressable memory (CAM). The CAM search key may comprise the virtual address and the search result is a physical address. If a requested address is present in the TLB 220, the CAM search yields a match quickly and the retrieved physical address can be used to access memory 112. This is called a TLB hit.

If the requested address is not in the TLB 220, it is a “miss”, and SMMU 210 proceeds by looking up the page table 240 in a process called a “hardware table walk.” The hardware table walk, relatively speaking, is an expensive process, as it involves reading the contents of multiple memory locations 112 and using them to compute the physical address. After the physical address is determined by the page walk, the virtual address to physical address mapping is entered into the TLB 220 as understood by one of ordinary skill in the art.

A master processing element 205 may issue a request to access a memory element 112 using a virtual address (“VA”). The memory request may also comprise a stream identifier. The SMMU 210 may receive this memory request and use the translation look-aside buffer (“TLB”) 220 based on the VA.

Once the SMMU 210 has the physical address for the page table from the memory request after it confirmed that the virtual address was not present in the TLB 220, it may perform a hardware table walk using the system bus 225 to access the protection unit 245. If the protection unit 245 grants access to the request, then the SMMU 210 may access the page table 240A in cache memory 230 or the page table 240B in the memory 112. As noted previously, the protection unit 245 is optional and may not be present in the system 101 as an alternate embodiment such that the SMMU 210 has direct access to memory elements 112.

After the SMMU 205 confirms a physical address within a page table 240B from a memory element 112, it may then store the virtual address and physical address together in the translation look-aside buffer (“TLB”) 220. The TLB 220 generally functions as a cache for the SMMU 210 as understood by one of ordinary skill in the art.

Meanwhile, the transaction history buffer (“THB”) 215 may capture the virtual address that was supplied in the memory request as well as the physical address which was determined by the SMMU 210 during its use of the TLB 220 or during a hardware table walk. The transaction history buffer 215 may further store memory attributes; a security bit; Virtual Machine Identifier (“VMID”); a Stream identifier (“SID”); SMMU Context Bank that was used; whether or not the virtual address was present in the TLB 220; and action taken by SMMU 210, which may include, but is not limited to: Bypass mode in response to a memory request, Translated address in response to a memory request, Page Fault for a physical address in response to a memory request, and Global Fault in response to in response to a memory request.

The THB 215 may further capture whether the physical address access by the bus master 215 behind the SMMU 210 caused a timeout/error on the bus. The THB 215 may further store an Origin of the Page Table Entry (“PTE”), which may include but is not limited to, the TLB 220, cache memory 230, and memory 112.

The transaction history buffer 215 may generally comprise hardware, such as, but not limited to, registers. The registers may be hardcoded to track the information noted above.

As understood by one of ordinary skill in the art, SMMUs 210 are typically for CPUs 110 which do not have their own MMUs. Similarly, Mobile Display processors in portable computing devices, such as mobile phones, will typically not have their own MMUs.

The SMMU 210 is useful for virtualization. Virtualization may allow an operator to run software that has two different types of operating systems, like DOS/WINDOWS™ and Macintosh for APPLE™ brand computer operating systems.

Meanwhile, the THB 215 has memory mapped registers which may receive commands from a CPU 110 running THB control software 114 to indicate when the contents of those registers should be locked for specific types of events/data. The THB 215 may be lockable to freeze its content in time for later retrieval so that its data is not overwritten until instructed to do so.

The CPU 110 via THB control software 114 may specify for which events that the THB 215 should lock its contents so that the contents may not be overwritten: Exemplary events may include, but are not limited to, when a page fault occurs, when a bus error occurs (i.e., a slave responded with an error), when a protection fault occurs (as issued by the protection unit 245) and other similar events. The SMMU 210 communicates these faults/errors and bus errors to THB 215.

An exemplary use case for the THB 215 may include when an error occurs on a device 101 where a bus master 205 tries to access a physical address that is invalid. Looking at the page tables 240 right after the invalid access based on the data recorded in THB 215 may reveal that this address is NOT mapped in the page tables 240. Looking at the SMMU configuration based on data within THB 215 right after the invalid access reveals that SMMU 210 may not have been in bypass mode.

The THB 215 may have an approximate size for storing data that ranges between about ten to about thirty entries. Each entry may be about 100 to about 200 bytes, yielding a total volume of about 600 bytes in an exemplary thirty entry scenario.

Referring now to FIG. 2B, this figure is a functional block diagram illustrating an alternative exemplary system for tracking transactions associated with a memory management unit 289. FIG. 2B is similar to FIG. 2A, therefore, only the differences between these two figures will be described.

FIG. 2B shows a system 101 in which the THB 215 is part of a conventional memory management unit (“MMU”) 289. This means that the MMU 289 only serves a single processing element 205, such as a single central processing unit 110. The MMU 289 does not serve any other processing element other than the central processing unit 110. Meanwhile, all functions as described above for the THB 215 remain the same.

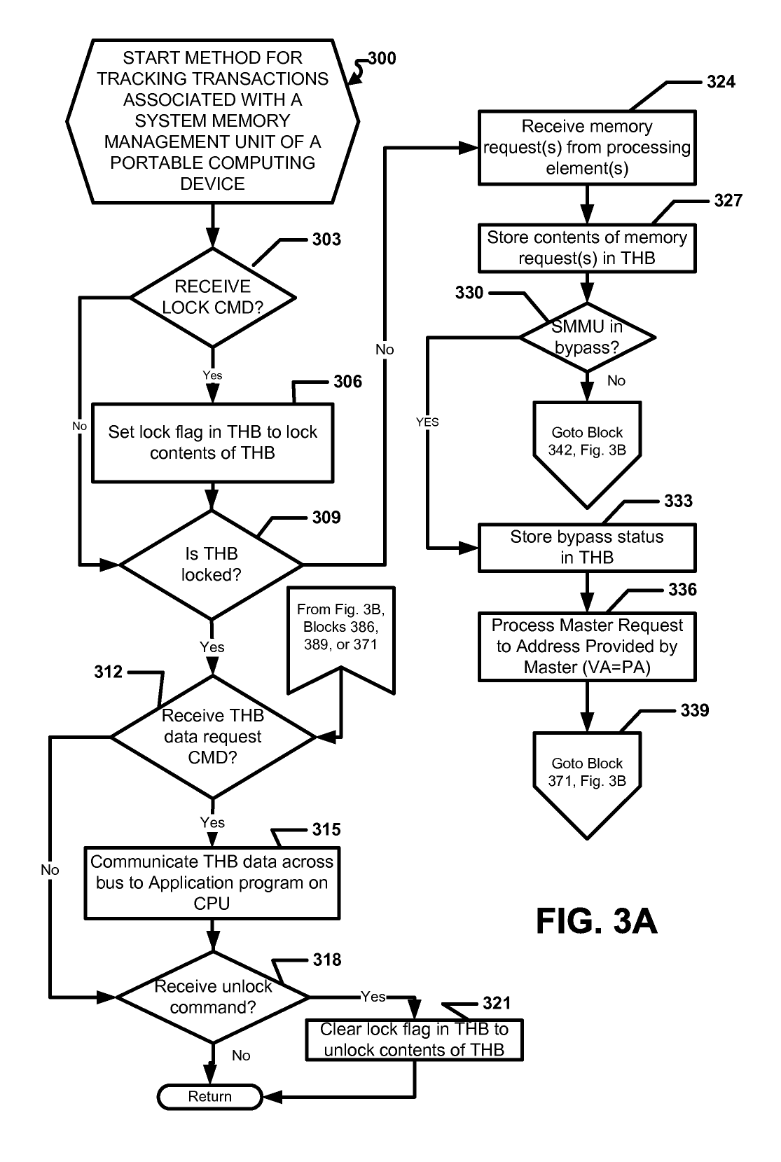

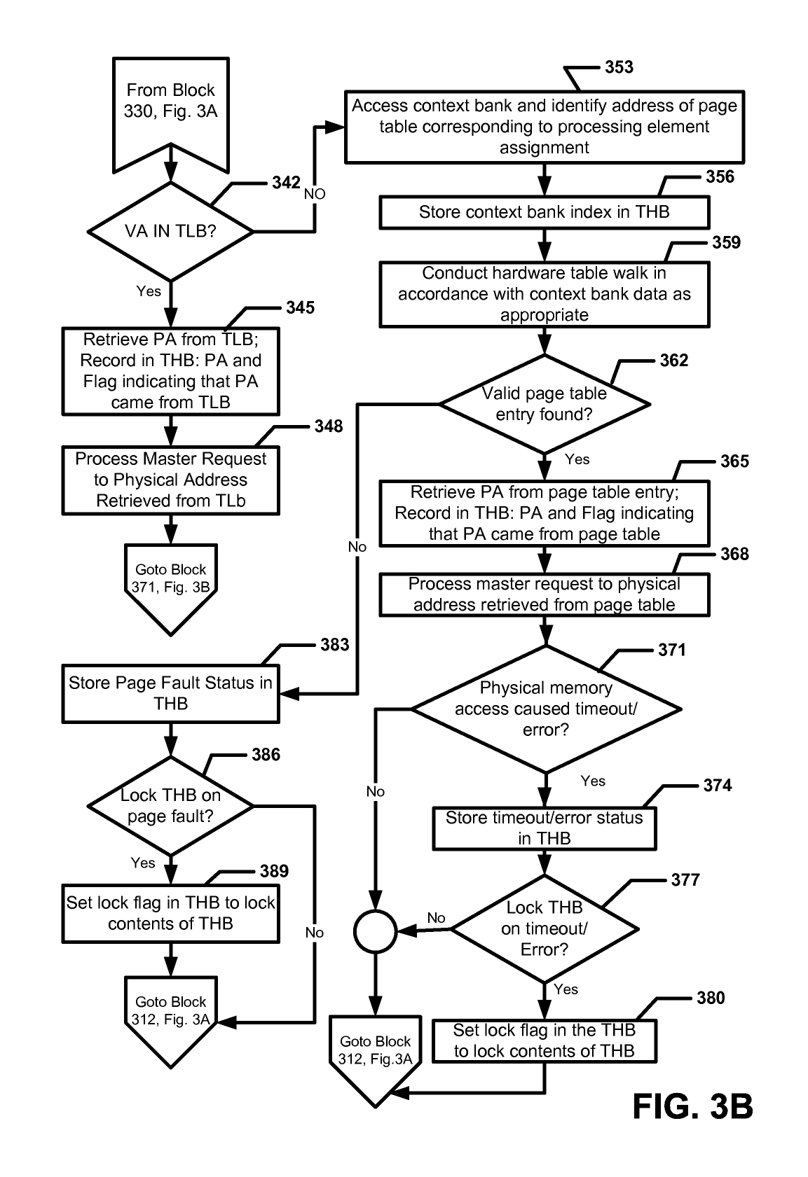

Referring now to FIG. 3A, this figure illustrates a logical flowchart of a method 300 for tracking transactions associated with a system memory management unit 210 of a portable computing device 100. Block 303 is the first step of method 300. In decision block 303, a transaction history buffer 215 may determine if a lock command has been received from control software 114 running on a central processing unit 110. If the inquiry to decision block 303 is negative, then the “No” branch is followed to decision block 309.

If the inquiry to decision block 303 is positive, then the “Yes” branch is followed to block 306. In block 306, the transaction history buffer 215 may set a lock flag in the transaction history buffer 215 so that the contents of the transaction history buffer 215 may not be overwritten until the lock flag is changed.

Next, in decision block 309, the transaction history buffer 215 determines if it is in a locked state. If the inquiry to decision block 309 is positive, then the “Yes” branch is followed to decision block 312. If the inquiry to decision block 309 is negative, then the “No” branch is followed to block 324.

In decision block 312, the transaction history buffer 215 determines if it has received a data request from a software 114 running on the central processing unit 110. Decision block 312 may also receive data from blocks 386, 389, or 371 of FIG. 3 B. as will be described in further detail below.

If the inquiry to decision block 312 is negative, then the “No” branch is followed to decision block 318. If the inquiry to decision block 312 is positive, then the “Yes” branch is followed to block 315.

In block 315, the transaction history buffer 215 communicates its data it has stored across the bus to 25 to the software 114 running on the central processing unit 110. Next, in decision block 318, the transaction history buffer 215 determines if it has received unlocked command from the software 114 running on the central processing unit 110.

If the inquiry to decision block 318 is negative, then the “No” branch is followed in which the method 300 returns to the beginning If the inquiry to decision block 318 is positive, then the “Yes” branch is followed to block 321 in which the transaction history buffer 215 clears its lock flag and unlocks the contents of the transaction history buffer 215 so that the contents may be overwritten with new data. The method 300 then returns back to the beginning at decision block 303.

Following the “No” branch from decision block 309, in block 324, the system memory management unit 210 may receive one or more memory requests from one or more processing elements 205A, 205B. In block 327, the transaction history buffer may store the contents of the memory requests within its memory space.

Next, in decision block 330, it is determine whether the system memory management unit 210 is in a bypass mode. If the inquiry to decision block 330 is negative, then the “No” branch is followed to decision block 342 and FIG. 3B.

if the inquiry to decision block 330 is positive, then the “Yes” branch is followed to block 333. In block 333, this bypass status of the SMMU 210 is stored in the memory of the transaction history buffer 215. Next, in block 336, the system memory management unit 210 may process master requests in which the system memory management 210 treats each virtual address is being identical to a physical address when in bypass mode as understood by one of ordinary skill in the art. The process then proceeds to block 339 and then on to block 371 of FIG. 3B.

Referring now to FIG. 3B, decision block 342 is reached from decision block 330 when the system memory management unit 210 is not in a bypass mode. In decision block 342, the SMMU 210 determines if the virtual address of a memory request is in the translation lookaside buffer 220. If the inquiry to decision block 342 is positive, then the “Yes” branch is followed to block 345. If the inquiry to decision block 342 is negative, then the “Yes” branch is followed to block 353.

In block 345, the SMMU 210 retrieves the physical address from the translation lookaside buffer 220. The transaction history buffer 215 also records this physical address any flag which indicates that the physical address was retrieved from the translation lookaside buffer 220.

Next, in block 348, the SMMU 210 processes the master request based on the physical address that it retrieved from the translation lookaside buffer 220. The process then proceeds to decision block 371 described in further detail below.

Following the “No” branch from the decision block 342, the SMMU 210 may access the context bank 217 and identify the address of the page table 240 corresponding to the processing element assignment. As noted above, each processing element 205 may be assigned to a particular context bank 217 as understood by one of ordinary skill in the art.

Next, in block 356, the transaction history buffer 215 may store the context bank index which was accessed in block 353 in its memory space. In block 359, the SMMU 210 may conduct a hardware table walk in accordance with the context bank data retrieved as appropriate and as understood by one of ordinary skill in the art.

Subsequently, in decision block 362, the SMMU 210 may determine if it has found a valid page table entry in a page table 240 for a particular memory request. If the inquiry to decision block 362 is positive, then the “Yes” branch is followed to block 365. If the inquiry to decision block 362 is negative, then the “No” branch is followed to block 383.

In block 365, the SMMU 210 may retrieve the physical address from the page table entry. Also in this block 365, the transaction history buffer 215 may record the physical address which was retrieved in this block 365 as well as a flag indicating that the physical address came from the page table 240. Subsequently, in block 368, the SMMU 210 may process the master request based on the physical address retrieved from the page table 240.

In decision block 371, the transaction history buffer 215 may determine if the physical memory access caused a timeout and or error to occur. If the inquiry to decision block 371 is negative, then the “No” branch is followed to block 312 of FIG. 3A. If the inquiry to decision block 371 is positive, then the “Yes” branch is followed to block 374.

In block 374, the timeout and or error status caused by the physical memory access is stored in the transaction history buffer 215. Subsequently, in decision block 377, the transaction history buffer 215 determines if the command was issued to lock the transaction history buffer 215 when a timeout and/or error occurred. If the inquiry to decision block 377 is negative, then the “No” branch is followed to block 312 of FIG. 3A. if the inquiry to decision block 377 is positive, then the lock flag in the transaction history buffer 215 is set to lock so that the contents of the transaction history buffer 215 are not lost and/or overwritten. The method 300 then proceeds to block 312 FIG. 3A.

Following the “No” branch from decision block 362 in which it was determined that a valid page table entry for the current memory request has not been found, in block 383, this page fault status is stored in the transaction history buffer 215. Next, in decision block 386, the transaction history buffer 215 determines if a command was issued by the software 114 running on the central processing unit 110 to lock the contents of the transaction history buffer 215 in situations where a page fault exists.

If the inquiry to decision block 386 is negative, then the “No” branch is followed to block 312 FIG. 3A. if the inquiry to decision block 386 is positive, then the “Yes” branch is followed to block 389. In block 389, the transaction history buffer 215 may set its lock flag such that the contents of the transaction history buffer 215 are not lost and/or overwritten. The process 300 then returns to block 312 of FIG. 3A.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium.

In the context of this document, a computer-readable medium is an electronic, magnetic, optical, or other physical device or means that may contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may include any means that may store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

Computer-readable media include both computer storage media and communication media including any medium that facilitates transfer of a computer program from one place to another. A storage media may be any available media that may be accessed by a computer. By way of example, and not limitation, such computer-readable media may comprise any optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for tracking transactions associated with a system memory management unit of a portable computing device, the method comprising:
receiving a plurality of memory requests from a plurality of processing elements;
storing contents of each memory request in a transaction history buffer;
determining if a virtual address in each memory request exists in a translation look-aside buffer;
retrieving a physical address from the translation look-aside buffer if it exists in the translation look-aside buffer and storing the physical address in the transaction history buffer and status that physical address was retrieved from the translation look-aside buffer;
if the virtual address in each memory request does not exist in the translation look-aside buffer, then accessing a context bank and identifying an address of a page table in memory corresponding to a processing element that originated a respective memory request;
storing a context bank index in the transaction history buffer corresponding to the memory request;
conducting a hardware table walk in accordance with the context data;
accessing an assigned page table in memory based on the physical address of the memory request; and
storing a result of the assigned page table access and any action taken by a system memory management unit in response to the result of the assigned page table access in the transaction history buffer.

2. The method of claim 1, wherein the contents of a memory request stored in the transaction history buffer comprises at least one of a security bit; a Virtual Machine Identifier (“VMID”); a Stream identifier (“SID”); a SMMU Context Bank that was used; whether or not the virtual address was present in the translation look-aside buffer.

3. The method of claim 1, further comprising: receiving a lock command for locking contents of the transaction history buffer and storing a status for the lock command in the transaction history buffer.

4. The method of claim 1, further comprising automatically locking contents of the transaction history buffer when at least one of a bus timeout, error, and a page fault occurs and storing a cause of the automatic locking in the transaction history buffer.

5. The method of claim 1, further comprising storing action taken by a system memory management unit in response to a memory request that comprises at least one of: storing a bypass mode status in the transaction history buffer; storing a translated address; storing a Page Fault for a physical address in response to a memory request;
and storing a Global Fault in response to in response to a memory request.

6. The method of claim 1, further comprising storing in the transaction history buffer whether a physical address access by a processing element originating a memory request caused a timeout/error on a bus.

7. The method of claim 1, further comprising storing in the transaction history buffer at least one of: an Origin of a Page Table Entry (“PTE”), which may comprise the translation look-aside buffer (“TLB”), cache memory, and memory.

8. The method of claim 1, further comprising receiving a request to program the transaction history buffer.

9. The method of claim 1, further comprising receiving a request to access contents of the transaction history buffer.

10. The method of claim 9, further comprising communicating data from the transaction history buffer across a bus to an application program.

11. A system for tracking transactions associated with a system memory management unit of a portable computing device, the system comprising:
means for receiving a plurality of memory requests from a plurality of processing elements;
means for storing contents of each memory request in a transaction history buffer;
means for determining if a virtual address in each memory request exists in a translation look-aside buffer;
means for retrieving a physical address from the translation look-aside buffer if it exists in the translation look-aside buffer and storing the physical address in the transaction history buffer and status that physical address was retrieved from the translation look-aside buffer;
means for accessing a context bank and identifying an address of a page table in memory corresponding to a processing element that originated a respective memory request if the virtual address in each memory request does not exist in the translation look-aside buffer;
means for storing a context bank index in the transaction history buffer corresponding to the memory request;
means for conducting a hardware table walk in accordance with the context data;
means for accessing an assigned page table in memory based on the physical address of the memory request; and
means for storing a result of the assigned page table access and any action taken by a system memory management unit in response to the result of the assigned page table access in the transaction history buffer.

12. The system of claim 11, wherein the contents of a memory request stored in the transaction history buffer comprises at least one of a security bit; a Virtual Machine Identifier (“VMID”); a Stream identifier (“SID”); a SMMU Context Bank that was used; whether or not the virtual address was present in the translation look-aside buffer.

13. The system of claim 11, further comprising: means for receiving a lock command for locking contents of the transaction history buffer and storing a status for the lock command in the transaction history buffer.

14. The system of claim 11, further comprising means for automatically locking contents of the transaction history buffer when at least one of a bus timeout, error, and a page fault occurs and storing a cause of the automatic locking in the transaction history buffer.

15. The system of claim 11, further comprising means for storing action taken by a system memory management unit in response to a memory request that comprises at least one of: storing a bypass mode status in the transaction history buffer; storing a translated address; storing a Page Fault for a physical address in response to a memory request; and storing a Global Fault in response to in response to a memory request.

16. A system for tracking transactions associated with a system memory management unit of a portable computing device, the system comprising:
a plurality of processing elements; and
a system memory management unit coupled to each processing element for managing memory requests generated by each processing element, the system memory management unit further comprising:
a translation look-aside buffer;
a context bank; and
a transaction history buffer coupled to the context bank and translation look-aside buffer, for storing contents of each memory request, for storing status information when a physical address is retrieved from the translation look-aside buffer, for storing a context bank index in the transaction history buffer corresponding to a memory request when a context bank is utilized by a memory request.

17. The system of claim 16, wherein the contents of a memory request are stored in the transaction history buffer and comprises at least one of a security bit; a Virtual Machine Identifier (“VMID”); a Stream identifier (“SID”); a SMMU Context Bank that was used; whether or not the virtual address was present in the translation look-aside buffer.

18. The system of claim 17, wherein the transaction history buffer supports a lock command for locking contents of the transaction history buffer and storing a status for the lock command in the transaction history buffer.

19. The system of claim 18, wherein the transaction history buffer supports an automatic lock when at least one of a bus timeout, error, and a page fault occurs and the transaction history buffer stores a cause of an automatic lock.

20. The system of claim 1, wherein the portable computing device comprises at least one of a mobile telephone, a personal digital assistant, a pager, a smartphone, a navigation device, and a hand-held computer with a wireless connection or link.
